(19) United States
(12) Patent Application Publication
(10) Pub. No.: US 2008/0271078 A1
(43) Pub. Date: Oct. 30, 2008

(54) Momentary Electronic Program Guide

(75) Inventors: Richard C. Gossweiler, Sunnyvale, CA (US); Mehran Sahami, Palo Alto, CA (US); David A. Brown, Mountain View, CA (US); Manish G. Patel, Mountain View, CA (US); John Blackburn, Newcastle, WA (US); Thomas H. Taylor, Redmond, WA (US); Neha Gupta, San Jose, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/742,444

(22) Filed: Apr. 30, 2007

(51) Int. Cl. H04N 5/445

(52) U.S. Cl. 725/40

(57) ABSTRACT

A computer-implemented method includes determining a time relative to a playing media program to insert a user notification, automatically generating a suggestion regarding a media program other than the playing media program to be presented to an audience member of the playing media program, providing, in a format for presentation on a user-related media player, the generated suggestion at the location in the playing media program, and causing the generation of a control that, when selected, performs an action related to the non-playing media program.

### TECHNICAL FIELD

This document discusses systems and methods for assisting viewers of media programming, such as television programming, in locating additional programming to review or watch.

### BACKGROUND

Many people are familiar with the phrase “57 channels, and nothing on.” We live in a time, both with respect to television programming and many other areas, in which we are inundated with content, and often have problems finding the content we want most. Search engines like the Google search engine go a long way toward helping users find various forms of content. In the realm of media programming, such as with television and radio, many people still find their content by “channel surfing.” As such, they may end up settling for whatever they stumble upon.

Electronic program guides, which generally display programming information in a grid defined by time and channels, can help users see quickly what is on other channels both now and in the future, and can do so while the current program is playing. With such program guides, a user generally calls up the guide manually and then scans around for other programs that might interest them. Of course, if the user does not choose to bring up the guide, is in the middle of a program, or does not review all of the available programs on the guide, they may not know about a program they may like better that is about to start.

### SUMMARY

This document describes systems and methods that may be employed to present viewers of television programming, or of other media programming, with suggestions for additional viewing. The suggestions may be made in the form of a program guide that appears temporarily, such as in an inconspicuous area of a television display, as an unobtrusive graphical element, or “bug.” The guide may show suggested programs to which a viewer may wish to change channels (whether real channels or virtual channels), and the suggestion may be targeted to inferred interests of the user, such as by looking to the program the user is currently watching, to prior user behavior and interests, or to behavior or interests of other users who are like the first user in their viewing habits or are acquaintances of the first user.

In one implementation, a computer-implemented method is disclosed. The method includes determining a time relative to a playing media program to insert a user notification, automatically generating a suggestion regarding a media program other than the playing media program to be presented to an audience member of the playing media program, providing, in a format for presentation on a user-related media player, the generated suggestion at the location in the playing media program, and causing the generation of a control that, when selected, performs an action related to the non-playing media program. Determining the time relative to the playing media program may comprise selecting a time for display of the user notification. The time can be selected as a period relative to an endpoint of a program segment and as a clock-based time, which may be the top or bottom of an hour.

In some aspects, the generated suggestion includes a programming schedule grid, and the programming schedule grid can display a personalized channel. The playing media program can also be recorded on a device operated by the user, and the non-playing media program is a broadcast program. In addition, the method may include transmitting the generated suggestion from a server to a remote display device. The method may also involve removing the display of the generated suggestion after a predetermined time period if the suggestion is not acted upon. The suggestion can be generated based on a similarity in subject matter between the playing program and the non-playing program. In addition, the method may include determining that the non-playing program is available for display to a user before providing the generated suggestion.

In another implementation, a computer-readable media having instructions recorded thereon is disclosed. The instructions when executed, perform the actions of determining a time relative to a playing media program to insert a user notification, automatically generating a suggestion regarding a media program other than the playing media program to be presented to an audience member of the playing media program, providing, in a format for presentation on a user-related media player, the generated suggestion at the location in the playing media program, and causing the generation of a control that, when selected, performs an action related to the non-playing media program. The generated suggestion can include a programming schedule grid, and the programming schedule grid can display a personalized channel. Also, the suggestion can be generated in a portable program module over a small portion of the playing media program.

In yet another implementation, a computer-implemented method is disclosed that includes automatically identifying an event, in a display of a first media program on a display device, for triggering a suggestion about a second media program related to the first media program, causing the suggestion to be displayed on the display device with the first media program, and providing information that causes the display device to switch to the second media program as a result of a user response to the suggestion. The suggestion can include a program associated with content of the playing program or with interests associated with a user associated with the display device. Also, the suggestion can include a plurality of programs that are each associated with content in the playing program or with interests associated with the user.

In another implementation, a computer-implemented system for generating media programming information is disclosed. The system includes a network interface to receive media programming information over an internet connection, a memory storing commands that, when executed, cause a suggestion about a non-playing media program to be provided over a playing media program, and a processor operating a program selector to identify characteristics about the playing program or a user associated with the playing program and to select the non-playing media program based on the identified characteristics. The the network interface, memory, and processor in the system may, in some aspects, be on a client device associated with a media player.

The systems and methods described here, in certain implementations, may provide for one or more advantages. For example, viewers of media content may be presented readily with additional content that may interest them. They can be spared the often time consuming and distracting chore of “surfing” for additional programming. In addition, users may be made aware of current or otherwise available programming that they might have missed. Content providers may gain by providing users with such a service, because the users may stay longer with the content providers and generate additional advertising revenue or other revenue or the content providers. And advertisers may benefit by being able to better target their advertising to users that are particularly interested in such advertising.

The details of one or more embodiments are set forth in the accompanying drawings and the description below. Other features, objects, and advantages will be apparent from the description and drawings, and from the claims.

### DESCRIPTION OF DRAWINGS

FIG. 1A shows a display of a temporary program guide grid around a playing media program.

FIG. 1B shows a display of a sports-related program guide over a playing media program.

FIG. 1C shows a display of a channel changing query over a playing media program.

FIG. 2 is a schematic diagram of a server-centered system for providing context sensitive suggestions to a viewer of a media program.

FIG. 3 is a schematic of a client-centered system for providing context sensitive suggestions to a viewer of a media program.

FIG. 4 is a flowchart of a method for providing programming suggestions to a viewer of a television program.

FIG. 5A is a swim lane diagram of a method for providing programming suggestions to a viewer of a television program. FIG. 5B is a another swim lane diagram of a method for providing programming suggestions to a viewer of a television program.

FIG. 6 is a flowchart of a method for selecting and showing programs targeted to a user.

FIG. 7 shows an example of a computer device and a mobile computer device.

Like reference symbols in the various drawings indicate like elements.

### DETAILED DESCRIPTION

This disclosure relates to systems and methods for providing a momentary program guide to be displayed on a media device at a location in a program, such as a television program displayed on a television, a commercial, or between programs. The momentary program guide can, among other things, provide one or more suggestions for follow-up programs based on the content of a current running program, the viewing preferences of a user, or other relevant factors. The user can then select one of the suggestions to switch to a suggested program, or ignore the suggestions, causing the momentary program guide to disappear after a set period of time.

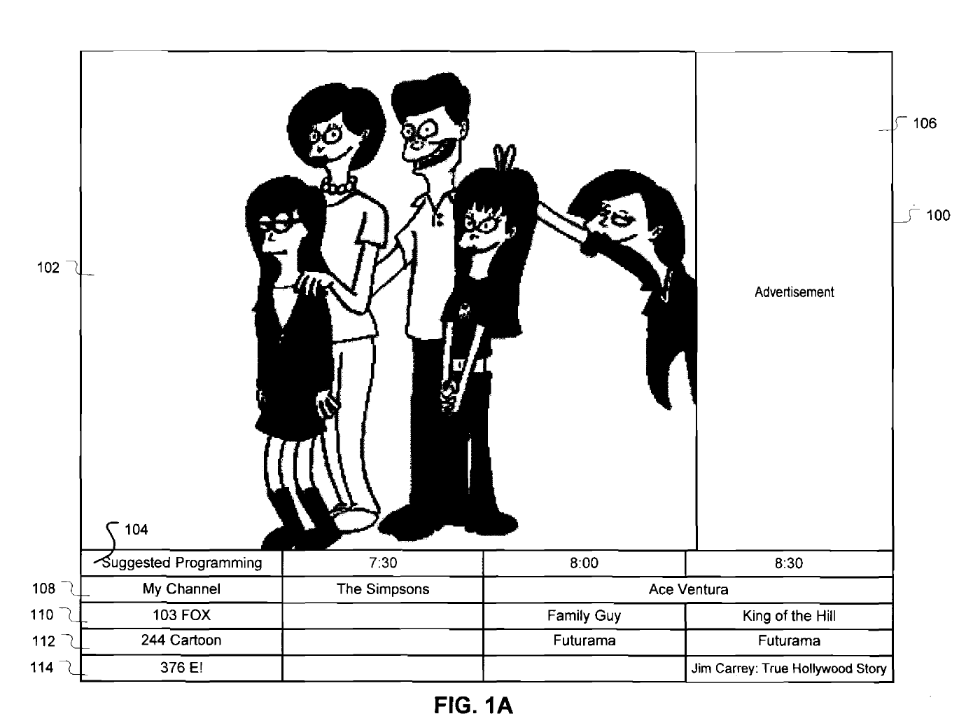

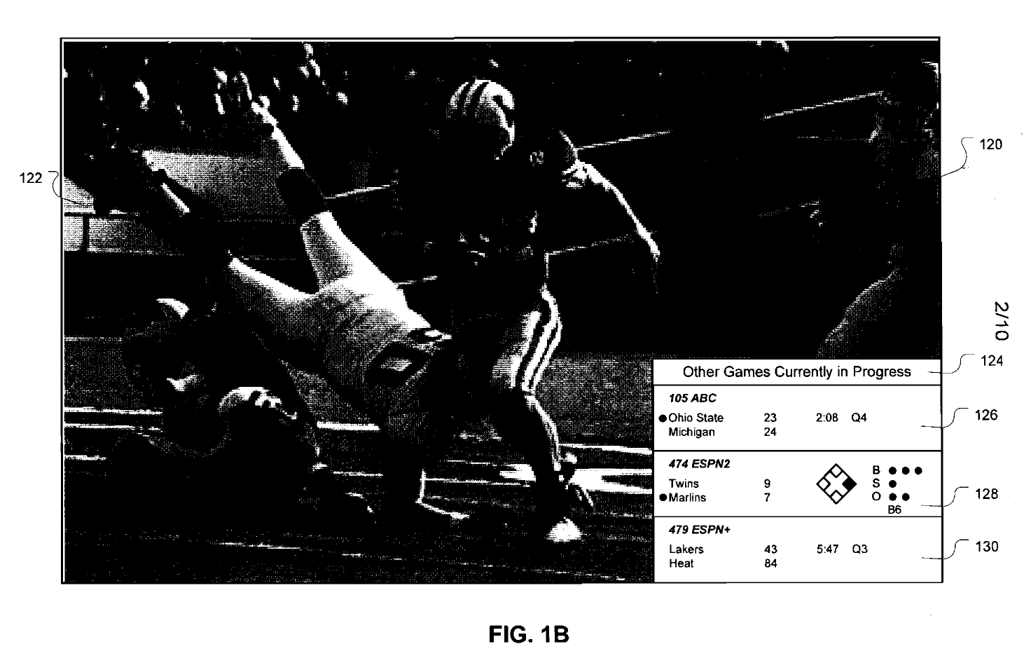

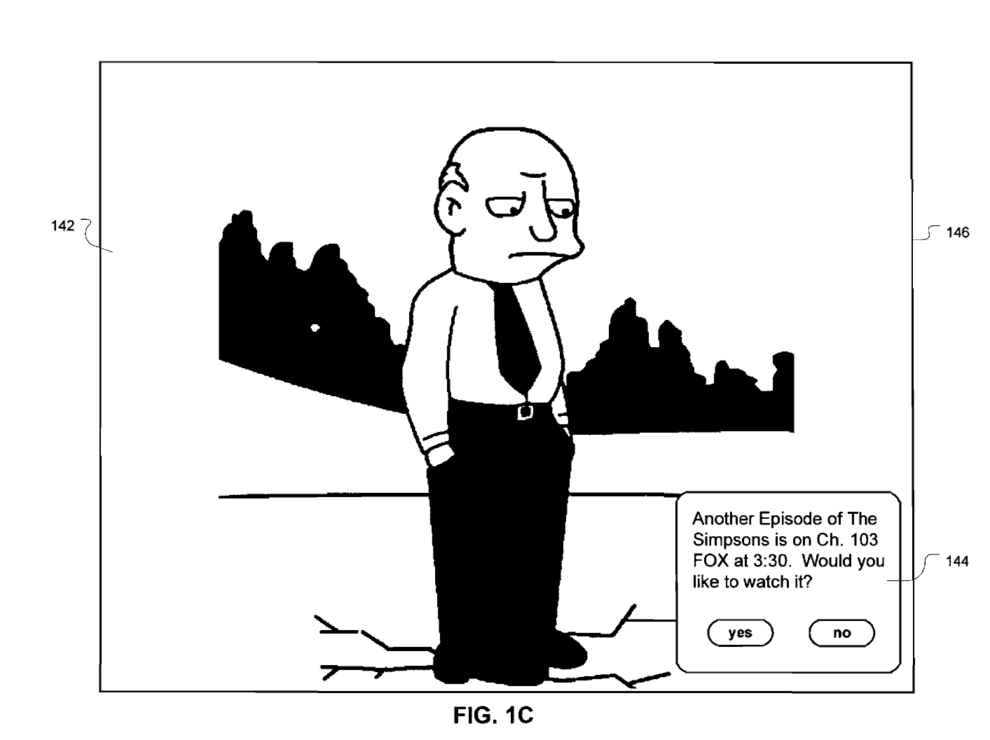

FIG. 1A shows a display 100 of a temporary program guide grid around a playing media program. In general, a user will be watching a television or other media program. A central system may determine that a break is about to occur in the program, such as the end of the program or a commercial break. At that point, the system may generate a display on the screen suggesting other programs that are either currently in progress or starting in the near future to which the user may want to switch. Such a display may also be triggered to appear at regular time periods, such as at the top or the bottom of every hour. In addition to program suggestions, the display may also include advertisements or other information that may be of interest to the user.

Alternatively or in addition, the display may occur before and/or after advertisements, or near the ends of advertisements. Such a display may preview the next advertisement and permit the user to skip it and see a different advertisement instead. Also, the user may be presented with programs to watch when coming out of an advertisement, or could be given the ability to select alternative endings (e.g., happy or sad) for a program. The operation of the display may be programmable and may depend on access to parameters such as an ID number for a follow-up suggested program, so as to enable functionality such as user-selected endings for programs.

The suggested programs that are displayed may be chosen based on their relation to the currently playing media program or their relation to the user's viewing preferences. If the user sees a program that he or she may be interested in watching, the user can select the program on the display and the media device will switch to the channel airing the selected program-either immediately or when the present program ends and the selected program begins. If the user chooses to ignore the program suggestions, the display will disappear after a set period of time.

The display may also occur as a full-screen replacement for live programming. For instance, at the end of a program, a television display may be switched to a display of a full electronic program guide grid. The user may ten be given the opportunity to select a next program in the grid to view. The options available to the user may include programs that will be broadcast soon (e.g., in the next few minutes), along with programs stored at a user's client device or that are available for streaming from an internet connected server. The user can select a next program, and if they do not select anything, their display device can make a selection for them or simply continue playing on the previously selected channel.

The program guide grid that is displayed with such a technique may be formatted in a variety of manners. It may include a time dimension and a channel dimension. In certain implementations, the time dimension may be limited solely to programs that will start in the near future. The guide may also be presented simply as a list of currently available programs (whether by broadcast, by streaming, or by accessing previously recorded programs). Certain programs that have been determined to be most relevant to the user may be highlighted in some manner. For example, relevant programs may be at the top of a list of programs, or the text or program guide grid cell for a program may be a color red for a very relevant program, down to blue for a very irrelevant program (much like a typical temperature map). The relevance of programs may be determined based on categorization of the program that is ending or just ended, or upon prior viewing habits of the user or the user's friends or acquaintances, among other things.

This technique of suggesting related and relevant programs may provide one or more benefits in various implementations. It may allow a user to easily find follow-up programs that he or she may be interested in viewing without having to search through a program guide that lists every available channel. This can increase user satisfaction and help build customer loyalty. The program suggestion technique can also provide programmers and advertisers with viewers that are more interested in the shows they are watching, and therefore more likely to respond to advertising associated with those programs. In addition, users may watch more television and thus generate more revenue for broadcasters.

The example depicted in FIG. 1A shows a display 100 containing a current running program 102, a momentary program guide 104 and an information panel 106, which in this representation is an advertisement. The advertisement displayed in the information panel 106 may be displayed because of its relevance to the current running program 102, or because the advertisement has been deemed particularly relevant to the user based on the user's program viewing history. In other implementations, the information panel 106 may display news, weather information, information relevant to the current running program 102, or other information that may be of interest to a particular user. For example, the information panel 106 may contain instructions on how to navigate the momentary program guide 104 using a remote control. Implementations of the display 100 may also be provided that only contain the current running program 102 and the momentary program guide 104, and do not contain the information panel 106.

The current running program 102 may be a television show broadcast by an over-the-air, cable, or satellite television provider, a program stored on a PVR or other media storage device, or a streaming media file hosted by a remote web server. The current running program 102 may be shrunk from its original size to make space for the momentary program guide 104 and for the information panel 106 on the display 100, or the current running program 102 may retain its original size, and images of the momentary program guide 104 and the information panel 106 may be overlaid onto the current running program 102.

As shown, the momentary program guide 104 is displayed at the bottom of the display 100, and the information panel 106 is displayed on the right side of the display 100, but other implementations may exist that place the momentary program guide 104 and the information panel 106 at other locations on the display 100. The momentary program guide 104 may appear a set time, such as a few minutes, before the end of the current running program 102, during commercial breaks, between programs, or at pre-described times such as a few minutes before the top or the bottom of the hour.

As shown in FIG. 1A, the momentary program guide 104 contains suggestions for other programs that the user may be interested in viewing. In this representation, the momentary program guide 104 is displayed as a grid in which the columns represent time segments occurring in the near future, and the rows show suggested channels. The momentary program guide 104 is different from a typical program guide because it displays channels that have been judged by the system to be particularly relevant to the user watching the visual display 100. For example, one of the channels may be a personalized channel 108 that displays content that has been personalized for the user or by the user.

The personalized channel 108 may be composed of various programs that the user selected at some earlier point. For example, the user may select a particular program and each episode of that program may then be included in the personalized channel 108. The user may also choose to drag programs from other channels into the personalized channel 108 to create a schedule of programs to watch. Furthermore, the programs displayed on the personalized channel 108 may be programs that are not currently being broadcast, but rather are inserted into the schedule off of a PVR associated with the visual display 100. For example, where programs in the personalized channel 108 overlap in time, a user may drag certain programs back in time to eliminate the overlap, and the later programs may be recorded and played back at the later time. These programs may be selected from the PVR based on how related a program on the PVR is to the current running program 102.

In addition to the personalized channel 108, other channels are shown that have been determined to have programs broadcast in the near future that have some similarity to the current running program 102, or are otherwise determined to be relevant to the user. For example, there may be a different episode of the same program as the current running program 102 broadcast on a different channel in the near future. Other suggested programs may include programs of the same genre, containing some of the same actors, or relating to a similar subject matter as the current running program 102. For example, if the current running program 102 is a situation comedy, the momentary program guide 104 may display suggestions for other situation comedies being broadcast in the near future.

Suggested programs can also include episodes of a user's favorite program, programs of a user's favorite genre, programs featuring a user's favorite actors, or programs relating to a user's favorite subject matter. For example, if the user's prior viewing history indicates an interest in World War II documentaries, the momentary program guide 104 may display a suggestion for a program on The History Channel about World War II fighter planes that is starting in the near future, or a similar program that is currently stored on the user's PVR.

If the user selects one of the suggested programs, the media device may immediately switch to the channel broadcasting the selected program, or the media device may switch to the channel broadcasting the selected program once the selected program begins airing. The media device may also wait until the program the user is currently watching ends, and may begin recording the other program if necessary, so that the user may watch the other program slightly behind where the program is airing, and can skip portions of the program to catch up with the program. Otherwise, if the user ignores the momentary program guide 104 and does not select a suggested program, the momentary program guide 104 may disappear after a set period of time.

In operation, the system described above can follow the example for presenting suggestions for follow-up programs as depicted in FIG. 1A. In this example, the user is watching an episode of The Simpsons. A few minutes before the end of the episode, the momentary program guide 104 appears, listing suggestions for programs that are being broadcast in the near future. Because no closely related program is being broadcast at 7:30, the momentary program guide 104 has inserted a previously recorded episode of The Simpsons from the user's PVR into the personalized channel 108 at the 7:30 time slot.

In the example, the momentary program guide 104 also displays a channel FOX 110 that is broadcasting an episode of Family Guy at 8:00 and an episode of King of the Hill at 8:30. This channel is being suggested because The Simpsons is a cartoon and Family Guy and King of the Hill are also cartoons. The system may also have access to information that suggests that viewers who like The Simpsons also generally like The Family Guy and King of the Hill. The momentary program guide 104 is also suggesting a channel Cartoon 112 that is broadcasting episodes of Futurama at 8:00 and 8:30. This program is being suggested because it is the same genre and is produced by the same creators as The Simpsons.

In the example, the user has previously chosen to have the movie Ace Ventura included in the personalized channel 108. Based on this user preference for programs featuring, or about Jim Carrey, the momentary program guide has displayed a channel E! 114 that is broadcasting a documentary regarding Jim Carrey in the near future. Programs on the various displayed channels that are not determined to be relevant or of interest to the user may be omitted in the guide 104, or may be shown in a manner that makes clear to the user that the shows are not being recommended, such as by presenting the text for such programs in a light gray rather than a black color.

The information panel 106 in this example contains an advertisement. The advertisement may be specially directed at the viewing demographic or demographics that enjoy The Simpsons. The advertisement may also be related to one of the suggested programs, or to information about the user's viewing habits.

FIG. 1B shows a display of a sports-related program guide over a playing media program. In general, this figure shows an alternative approach for displaying a momentary program guide when the user is watching a sports program. A central system has determined that the game is over, or nearly over, or that a break is about to occur, such as half time or a commercial break. Alternatively, the central system may have determined that the game currently being viewed has become boring because the difference in score is so high. Upon making one of these determinations, the system will display a momentary program guide to recommend other games that are currently in progress or about to begin to which the user may want to switch. Furthermore, the momentary program guide may include information about each of the recommended games, such as the score and time remaining, so that the user can decide if one of the suggested games would be more exciting to watch.

In the example depicted in FIG. 1B, the display 120 shows a current sports program 122 and a momentary program guide 124. In this implementation, the momentary program guide 124 appears as a pop-up in the lower right-hand corner of the visual display 100. The momentary program guide 124 may be triggered to appear near the end of the current sports program, such as when less than two minutes remain on the clock for a football or basketball game.

The momentary program guide 124 may also be triggered to appear when it is determined that the user may want to stop watching the current sports program 122, such as if the difference in score is very high, or if the game is approaching halftime. That determination may be made manually if someone at a central system watches the game and provides a setting on that central system that can be accessed by a system associated with the visual display 100, to indicate that the game has become boring. The determination may also be made automatically by a system that has access to a real time data feed of the score and time statistics for the current sports program 122. The system may then use this data to determine if the current sports program is nearing a break, or if the difference in score has reached an amount determined to be insurmountable given the current time remaining in current sports program.

In such a situation, the system may then decide to gather information on other related programs that are currently being broadcast or will be broadcast in the near future on other channels, or possibly the current channel. In addition, the system may locate relevant programming stored on a device such as a PVR locally to the user, or on a server remote from the user (such as Google Video or You Tube videos). The momentary program guide 124 may then appear and display suggestions for other programs based on this information. In this example, because the program being viewed is a sports program, the program suggestions may contain recommendations for other games that are currently in progress or about to begin.

The momentary program guide 124 may not only display suggestions for other sports programs that are currently being broadcast, but can also include information about the score, time remaining, or other relevant statistics for the suggested sports programs. The user may then use the information displayed for each suggested sports program to determine if he or she would like to switch to the channel airing one of the suggested sports programs. Selections may occur, for example, by the user pressing arrow keys in a four-way navigation selector on a remote control, and then by selecting a highlighted program. If the user selects one of the suggested sports programs, the display 100 will switch to the channel displaying the selected program (either immediately or at a later time). Otherwise, if the user ignores the momentary program guide 124 and does not select a suggested program, the momentary program guide 124 will disappear after a set amount of time.

In operation, the system described above may follow the example depicted in FIG. 1B. In this example, the current sports program 122 is a football game between Wisconsin and Northwestern. A remote system such as one of the systems mentioned earlier has determined that the difference in score of the game has become very high and therefore, that the game may have become boring to watch. This causes the momentary program guide 124 to appear on the visual display 100.

The momentary program guide 124 contains a program suggestion 126 for a football game between Ohio State and Michigan that is currently being broadcast for which the score is much closer. The system has determined that the game displayed in the program suggestion 126 would be of high interest to the user since it involves teams in the same conference as the teams in the game that is currently being watched. The system has also determined that the game suggested in program suggestion 126 is a more exciting game than the game currently being watched since the score is close, and the game is getting close to the end. The program suggestion 126 displays the channel the game is on, the teams playing, the score, the time remaining, and a graphic indicating which team currently has the ball so that the user can make a more informed decision as to whether to continue watching the current sports program 122 or switch to the game displayed in the program suggestion 126.

The momentary program guide 124 also contains a program suggestion 128 for a baseball game between the Twins and the Yankees that is currently being broadcast. The central system may have used information from the user's head-end to determine that the user lives in Minneapolis, and therefore may be interested in watching a Twins game. The game might also be between two teams that are currently in a playoff hunt (as determined, e.g., from internet-accessible standings information), and therefore the system has determined that the game would be more exciting to watch. The program suggestion 128 displays the channel the game is on, the teams playing, the score, the inning and other relevant baseball information such as the current number of balls, strikes and outs. The program suggestion 128 also includes a graphic depicting which bases currently have runners. The user can use all of this information to determine if he or she would like to switch to this baseball game.

The momentary program guide 122 also contains a program suggestion 130 for a basketball game between The Lakers and The Heat. Even though the basketball game in the example has a high difference in score, it may have been selected for display by the system based on a user preference for Lakers basketball games. The program suggestion 130 displays the channel the game is on, the teams playing, the score, and the time remaining. The user can use all of this information to determine if he or she would like to switch to this program.

Although invocation of the momentary program guide 124 has been described above as occurring at a certain time, such as near a break in the program being displayed, the invocation may occur by other mechanisms also. For example, a remote control button or a menu command may be reserved for the momentary program guide 124, so that when a user is unsatisfied with the program they are watching, they can press the button and see several other programs currently playing or about to begin, for which the system has determined the user may have a special interest.

The momentary program guide 124 may be implemented as an on-screen gadget, such as a gadget following an API for Google Gadgets. As such, the guide may be generated by a portable program module that can be executed by a number of different systems as part of a container document. In one example, a client device generating the momentary program guide may be equipped with a JavaScript runtime component that may access information over the internet for posting in a program guide. Such interaction may occur by submissions made by JavaScript or other mechanisms to a central server, followed by a response from the server using XML-based or other information. The organization may thus follow AJAX programming techniques. The run time component may also interact with a tuner in a client device to cause the tuner to change to a different channel, and may also operate a media player that can played stored programs or obtain streaming content.

In certain implementations where a media player has access to two tuners (which is currently the case with various digital video recorders), the program guide may monitor and display content from a tuner that is not delivering the current main content for a display. For example, the system generating the guide may monitor text in a closed caption system and provide a program guide that displays the feed from a second tuner when a certain event occurs. As one example, the program guide may look for terms like “score,” “first down,” or touchdown, and may pop up a gadget showing video from a second tuner when such an event occurs, so that a user may switch channels to the other event and see replays of a recent exciting happening.

The video for the program guide may also be retrieved (e.g., as a relatively small number of video frames) from the internet, and the program guide may cause a device to change channels to a channel associated with the video. For example, an internet service may not be capable of streaming a live football game to many viewers, or such action may be inefficient. However, the service may provide a signal and a limited amount of video anytime an exciting play occurs in the game. Users may be shown that video in a program guide, such as in a corner of the display (where the position of the guide may be adjusted to any corner or another location) so that they can determine whether to switch to the football game, but once they choose to switch, they will receive content from their terrestrial, satellite, or cable provider.

The generation of the momentary program guide may be started manually or automatically. Manual instigation may happen by a user pressing an appropriate remote control button or selecting a particular control on a displayed menu. Automatic control may occur in manners like those described above, for example, at a set time before the end of a program, when a data feed indicates that an interesting event has occurred in another program (e.g., as determined internally by a client device such as by monitoring closed caption text, or as determined externally, such as by a third party provider sending a message that a scoring event has occurred during a sports program).

Where the generation of the guide is started by automatic mechanisms, filters may be applied to prevent generating a guide at inopportune times. For example, a user may set a variable to block generation of program guides. The user may also indicate an interest in not having program guides generated over certain favorite programs.

The particular guide may be contextually affected in certain manners other than those discussed above also. For example, the guide may show what is currently on for particular channels such as a user's favorite channels. In addition, the guide may be configured to show only what is on a particular channel for a certain time period, such as the next program on the current channel.

The shows provided in a guide may also be based on various other contextual cues. For example, content of the current show and/or the time in a show at which the guide is being requested may b used to select alternative shows to display. For example, XML may be used to tag times in a show and associates tags. When a guide is generated at times associated with the tags, a search may be generated using information in the tags, such as:

```
        <XML 1.0>
            <Channel 13>
                <time gmtStart=011020304 gmtEnd=1020230430>
dog?car?anna nicole smith?money</time>
                <time...>tagwords?tagword</time>
            ....
```

Other contextual factors may also be used to select suggested programs. For example, the time of day may affect selections, where evenings may result in the showing of more comedies and news, and selections before 8 p.m. may include shows with family-friendly ratings. The type of device being viewed may also affect the selections (e.g., television, computer, or mobile device), either because the device may not be capable of displaying certain programs and/or certain programs are deemed to be particularly relevant to users of a certain class of device. The location of the device may also be relevant, such as can be determined by an IP address (to target content based on a region or country).

Selections of programs to suggest may also depend on social factors. For example, a user may identify themselves as part of a social group, such as a group of friends or a club (e.g., an on-line group of home remodeling enthusiasts). A momentary program guide, such as a guide in the form of a gadget displayed as a “bug,” may suggests shows that many members of a group of friends or a club have chosen to watch. The determination may also be made using profile information for a user and/or members of their social network. For example, an analysis of members in a remodeling club may indicate that many of them use terms like “home improvement” on their web pages or in their chat conversations, that many of them use similar terms in their search requests, or that many of them visit home improvement web sites. Therefore, when a member of the group is nearing the end of a program, a momentary program guide may present options from HOME, and HGTV channels, even if the program the user was previously watching had nothing to do with remodeling or home improvement.

A program guide may also provide a user with a control whose selection causes details about an episode or program to be displayed. For example, the user may navigate to a hyperlink, and selection of the hyperlink may cause an entire page that shows details about a particular program (e,g, broadcast times for various episodes, image search results, a list of actors and the like, etc.) to be displayed. In applications such as IPTV, video streams from various programs may also be shown, either in a program guide or in a details page about a number of programs that is shown in cooperation with the display of a program guide.

FIG. 1C shows a display of a channel changing query over a playing media program. In general, this figure shows an alternative approach for displaying a momentary program guide when the system wants to present a single program suggestion to the user. This technique for displaying a momentary program guide would generally be used only when the suggested program is highly related to the current playing media program, or is determined to have significant relevance to the user.

In this figure, the display 146 shows a current running program 142 and a channel changing query 144 presenting a momentary program guide. In this implementation, the channel changing query 144 appears as a pop-up in the lower right-hand corner of the visual display 100. This implementation shows the channel changing query 144 suggesting a single particular program that may be especially relevant to the user. For example, if the current running program 142 is an episode of The Simpsons, the channel changing query 144 may suggest another episode of The Simpsons that is about to start on a different channel, or that is currently stored (from being recorded earlier) on the user's client device. Here, the user can select “yes” using their remote control to switch to the suggested channel upon the completion of the current running program 142, or select “no” to continue watching the current running program 142 and make the channel changing query 144 disappear. If the user ignores the channel changing query 144, it may disappear after a set period of time. A selection to change the channel will cause a program associated with the guide to send a command to a tuner or media controller to switch to and play the selected program.

In operation, the presentation of a single channel changing query as opposed to a list of suggestions would generally relate to suggestions for other close-arriving programs—for example, programs that start just as the current running program 142 ends. This implementation may also, in appropriate circumstances, display suggestions that are deemed highly relevant to the user, such as another episode of the same program as the current running program 142 or a program that is determined to be of high interest to the user. For example, if the user's viewing history indicates a high preference for the show Seinfeld, the channel changing query 144 may suggest a new episode of Seinfeld that is about to start on a different channel. The system may also be pre-programmed by the user to display an alert whenever a particular program or sports event is about to start. For example, the user may program the system to show a channel changing query whenever a Twins baseball game is about to start. As another example of the use of a single channel changing query, if the current running program 142 is a program about dog training, the channel changing query 144 may suggest a broadcast of a dog show that is about to start or is currently in progress on a different channel.

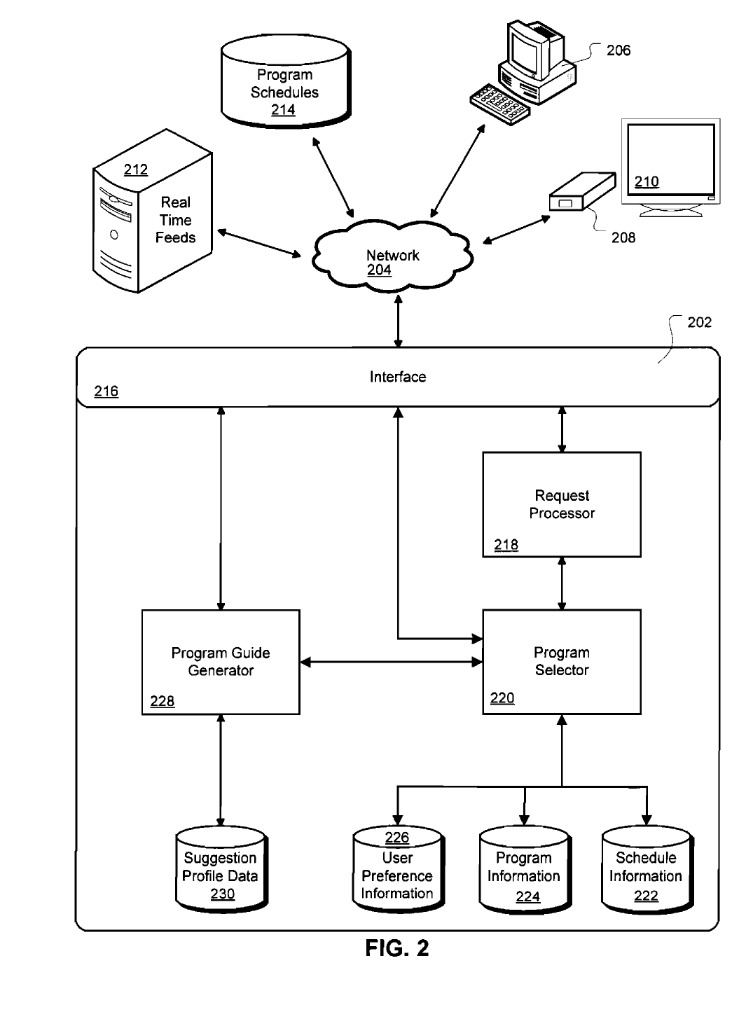

FIG. 2 is a schematic diagram of a server-centered system 200 for providing context-sensitive suggestions to a viewer of a media program. In general, a server-centered system 200 contains a suggestion generating system 202 that receives input from several data sources which may including a source of video media and a TV listings database or other such program schedule database. The suggestion generating system 202 uses information from these data sources to generate programming suggestions to display to a viewer of a media program.

In general, the suggestion generating system 202 contains components to interact with data and media content servers, as well as end user clients. In the example, the suggestion generating system 202 is shown to communicate with the servers and clients via a network 204, such as the internet or a cable network. The two examples of end user clients shown here are a desktop computer 206 and a receiver box 208 connected to a flat screen TV 210. These are two common devices that are used to view video media, but any appropriate video media playing device, such as a web-enabled cell phone, may be an end user client of the suggestion generating system 202.

Here, the suggestion generating system 202 is also connected via the network 204 to a media content server 212 that provides real time video feeds, for example from a cable or satellite television provider. In other implementations, the media content server 212 would not have to provide real time feeds, but may provide other forms of video content. For example, the media content server 212 may be a PVR or a web server that provides video content.

The suggestion generating system 202 is also connected via the network 204 to a program schedule database 214. The program schedule database 214 provides program scheduling data to the suggestion generating system 202. The program schedule database 214 may represent one or more TV listings data supply companies, such as TV Guide, Digi-Guide, XML TV, BDS, or Ananova. These companies can supply TV listings data in numerous formats, including XML, HTML, RTF and TSV (Tab Separated Values).

In addition to the data servers depicted in this example, other data servers that the suggestion generating system 202 may draw information from may include weather or news feeds to be displayed in an information panel similar to the information panel 106 depicted in FIG. 1A. The suggestion generating system 202 may also draw information from a sports statistic server that provides real time feeds of game scores and other statistics to be displayed along with program suggestions in a format similar to the momentary program guide 124 depicted in FIG. 1B.

The suggestion generating system 202 communicates with the network 204 using an interface 216, which may take the form of one or more web servers and other such hardware, or may take other appropriate forms. In this example, the suggestion generating system 202 uses information provided by the media content server 212 and the program schedule database 214 to determine when a momentary program guide should be displayed, which program or programs should be included in the momentary program guide, and how to display the information to the user.

The suggestion generating system 202 contains a request processor 218 that receives requests from desktop computer 206 and a receiver box 208, such as requests to show relevant alternative programming information. The request processor 218, may, for example, parse out information from a request, such as a user identifier and an identification of a program currently being watched by the user. The request processor 218 can also receive notices from the media content server 212 indicating when the end of a program or breaks in a program are occurring. The request processor 218 can use this data to determine when a momentary program guide should be displayed. For example, if a user is watching a football game, and the game is approaching halftime, the media content server 212 can send a signal to the request processor 218 indicating that a break in programming is about to occur for that program. The request processor 218 can then determine whether or not to display a momentary program guide for a user, based on information known to the request processor about the channel the user is currently watching.

The request processor 218 can also use data from the program schedule database 214 to determine if a momentary program guide should be displayed. The request processor 218 can check the program schedule data at regular intervals, such as near the top and bottom of the hour, to see if a user favorite program or a relevant program is about to start on a different channel. For example, if a user's favorite program is about to begin, the suggestion generating system 202 can display a momentary program guide similar to the channel changing query 144 from FIG. 1C, asking if the user would like to switch to the channel airing the program.

Once the request processor 218 has determined that a momentary program guide should be displayed, it will send a signal to a program selector 220 within the suggestion generating system 202 that will select one or more programs to suggest to the user. To select which programs to suggest to the user, the program selector 220 draws data from several databases including a schedule information database 222, a program information database 224, and a user preference database 226. The depicted example shows these databases located within the suggestion generating system 202, but other implementations may exist in which one or more of these databases is located remotely and accessed via the network 204.

The program selector 220 first determines the user's head-end, and thus what channels are available to the user. The schedule information database 222 is populated with data containing program schedule information received from the program schedule database 214 that pertains to the user's head-end. For example, in the case where the media content server 212 is a cable provider, the schedule information database 222 may contain TV listings for all of the channels available to the user through the cable provider.

The program information database 224 contains information for programs being broadcast, either currently or in the near future, on channels available to the user that may be used to determine program suggestions to display in a momentary program guide. The program information database 224 also contains information on the current running program. This information may include program titles, program genres, program subject matters, actors in the program, program writers, program creators, ratings data, viewer demographics, or information on reviews of the program. For example, a program can be recommended because it was given four stars by the New York Times.

The information stored in the program information database 224 may also include information on awards received by a particular program. For example, a movie that has won several Academy Awards or a television show that recently won an Emmy award may be suggested. In the case of sports programs, the program information database 224 may also include information on which teams are playing, which conferences the teams are in, whether or not the game has playoff implications, and the point spread for the game. All of this information may be used to determine how exciting the game might be and, therefore, how interested a user would be in the sports program.

In the example, the user preference database 226 contains data on the user's viewing preferences. This information may have been directly input by the user at an earlier time, or determined by the system based on the user's program viewing history. For example, the user may input a preference for program's featuring Adam Sandler, or if the user has recently watched several program's about World War II, the system may determine that the user has a preference for programs about World War II. The information stored in the user preference database 226 may include a user's favorite programs, favorite genres, favorite subject matters, favorite actors, favorite writers, favorite program creators, and favorite sports teams.

Once the program selector 220 has received a signal from the request processor 218 indicating that one or more program suggestions should be generated, the program selector 220 may gather information from the program information database 224 and the user preference database 226 about the current running media program and the user's viewing preferences. The program selector 220 may then determine the time window from which potential program suggestions should be selected. In general, this time window may be the next few hours, although the time window may be longer or shorter. Next, the program selector 220 may access the schedule information database 222 to create a program list of programs that are being broadcast within the time window.

The program selector 220 may then collect information for each program in the program list from the program information database 224 and compare the information for each program to the previously collected information about the current running media program and the user's viewing preferences, to determine which programs in the program list are related to the current running media program, or relevant to the user's viewing preferences. Based on these comparisons, the program selector 220 may determine which programs would be most relevant to the user, and select the channels broadcasting these programs as the channels to be suggested to the user. If a single program is determined to be particularly more relevant to the user than any other program in the time window, the program selector may choose to suggest only that one program. In such a case, a momentary program guide similar to the channel changing query from FIG. 1C would be displayed to the user.

Once the program selector 220 has selected one or more programs to suggest to the user, it will pass this information to a program guide generator 228. The program guide generator 228 creates code for a momentary program guide to display to the user. The program guide generator 228 draws data from a suggestion profile database 230 that contains text and graphics for various suggestion profiles such as the momentary program guides and channel changing queries described above.

Based on the number of programs and the type of programs selected by the program selector 220, the program guide generator 228 may select a suggestion profile from the suggestion profile database 230 and populate the suggestion profile with information received from the program selector 220, such as program titles, the channels broadcasting the suggested programs, and the times the suggested programs are scheduled to broadcast. For example, if multiple-program suggestions are received from the program selector 220, the program guide generator 228 may select a suggestion profile from the suggestion profile database 230 similar to the momentary program guide 104 shown in FIG. 1A. The program guide generator 228 may then populate the grid spaces in the momentary program guide with the titles of the suggested programs, the channels broadcasting the suggested programs, and the times the suggested programs are being broadcast.

In other implementations, the program guide generator 228 may receive information from external data sources. For example, if the program suggestions generated by the program selector 220 are for sports programs currently in progress, the program guide generator 228 may access a live feed of scores and other statistics for the suggested sports programs, and display this information along with the program suggestions, similar to the momentary program guide 124 shown in FIG. 1B. Once the program guide generator 228 has created the momentary program guide, it will send the code for the momentary program guide to the end user client via the network 204, to be displayed to the user.

In operation, a user may be watching a television program being transmitted by a cable service provider. For example, the user may be watching an episode of The Simpsons. As the program is nearing a break, the cable provider transmitting the program may send a signal to the suggestion generating system 202 indicating that a break in the current program is about to occur. The request processor 218 may then determine that a momentary program guide should be displayed to the user. The request processor 218 may then send a signal to the program selector 220 indicating that program suggestions should be generated. Following the example, the program selector 220 may determine that the user is watching an episode of The Simpsons. The program selector 220 may then gather information from the program information database 224 about The Simpsons.

The program selector 220 may also gather information from the user preference database about the user's viewing preferences and then compare this information, and the information about The Simpsons to information about all of the programs being broadcast in the next two hours that are available to the user. Since The Simpsons is a cartoon that is generally aimed at adults, the program selector 220 may select other adult oriented cartoons, including other episodes of The Simpsons, to be suggested to the user. For example, if an episodes of Family Guy and King of the Hill were starting in the near future, the program selector 220 may most likely select these programs to suggest to the user. The program selector 220 might also select other programs in the broader genre of adult comedy if there are no adult oriented cartoons being broadcast in the near future. The program selector 220 may also select programs to suggest based on the user's viewing preferences. For example, the viewer has a strong preference for John Candy movies, the program selector 220 may suggest a broadcast of the movie Uncle Buck that is starting in the near future.

The program selector 220 may then send the selected program suggestions to the program guide generator 228. Following the example, the program guide generator 228 may select a suggestion profile from the suggestion profile database 230 that represents a grid for displaying multiple channel suggestions. The program guide generator 228 may then insert the names of the suggested programs, the channels broadcasting the programs, and the times the programs are scheduled to broadcast into the suggestion profile to create a momentary program guide. The momentary program guide may then be transmitted to the end user client via the network 204 and displayed to the user.

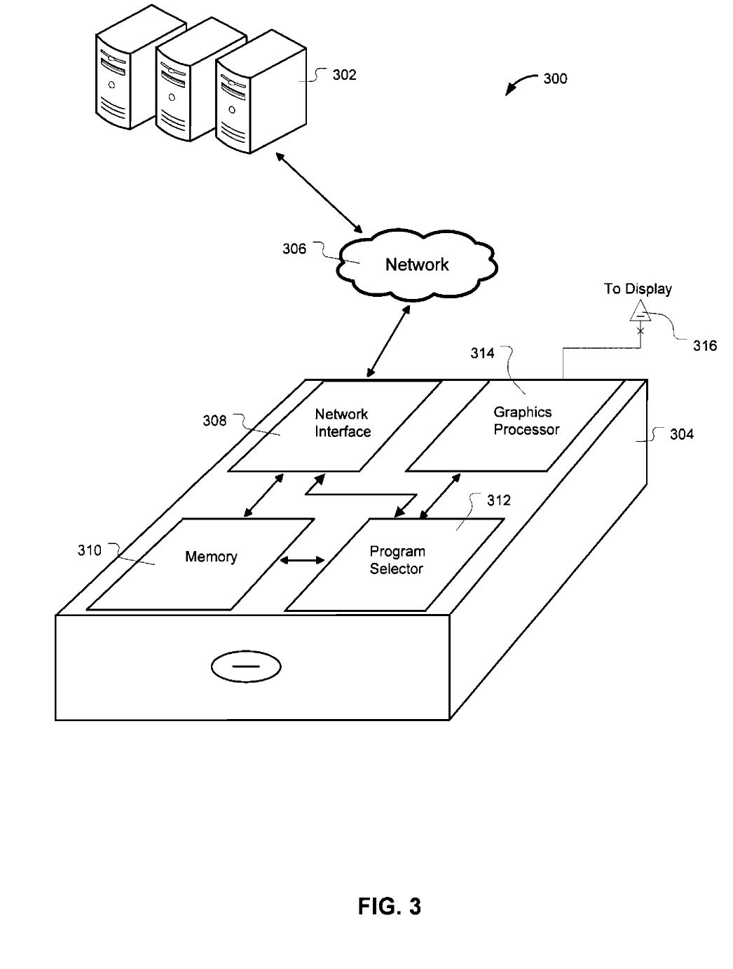

FIG. 3 is a schematic diagram of a client-centered system for providing context sensitive suggestions to a viewer of a media program. In general, the figure depicts a guide generating device 304 that may be used to overlay program suggestions on a current running media program. The guide generating device 304 represents a collection of hardware and software components used to generate and display a momentary program guide that may generally be located on the user end of a network 306 near the media viewing device playing the current running media program.

The guide generating device 304 may have various levels of functionality. For example, a simple implementation of the guide generating device 304 might only have the ability to send information to one or more remote servers about the user's identity, the user's viewing preferences, and what program the user is currently watching. The device may then simply display whatever content it receives back from the remote server in a particular format and at a particular time as dictated by the server.

A more complex implementation of the guide generating device 304 may perform all of the functions of the suggestion generating system 202 described above with respect to the program selector 220. Such a complex implementation may also contain a program guide generator similar to the program guide generator 228 in FIG. 2 to format the selected information into what will be viewed on the display. The guide generating device 304 may contain numerous other combinations of full or partial functionality. For example, the program suggestions may be selected remotely, and the guide generating device 304 may contain a program guide generator to format the information received from the remote server into a momentary program guide to be displayed to the user.

In the example in FIG. 3, The guide generating device 304 is depicted as a stand alone device, but implementations may exist in which the guide generating device 304 is a component within a television receiver or another media receiving device. The guide generating device 304 is connected to one or more remote servers 302 via the network 306. The network 306 may be the Internet, or a cable line connected to a central cable network. The remote servers 302 send real time or pre-recorded video media feeds to the guide generating device 304. The remote servers 302 also send program schedule data, program information, and other relevant information to the guide generating device 304. The guide generating device 304 will use this information to generate program suggestions and display those suggestions to a user in a process similar to that described above for the suggestion generating system 202.

Here, the guide generating device 304 contains a network interface 308 to receive media programming information transmitted by the remote servers 302 via the network 306. In other implementations, such as the simple implementation described above, the network interface may also send information, such as the user's viewing preferences and the program identification of the current running media program to the remote servers 302 so that the program suggestions may be generated remotely.

The guide generating device 304 also contains a memory 310 that stores a set of computer commands that, when executed, cause a suggestion about one or more non-playing media programs to be provided over the current running media program. The guide generating device 304 contains a program selector 312 to read and execute some or all of the commands stored in the memory 310. The program selector 312 my use information received from the remote servers 302 via the network 306 and the network interface 308 to create a list of one or more non-playing programs to suggest to the user. The program selector 312 may generate these program suggestions in a process similar to that described above for the program selector 220 from FIG. 2.

Once the program selector 312 has selected one or more programs to suggest to the user, a graphics processor 314 contained within the guide generating device 304 may generate a display of information about the suggested programs. The graphic display generated by the graphics processor 314 may resemble any of the previously described momentary program guides, such as the momentary program guide 104 shown in FIG. 1A, the momentary program guide 124 shown in FIG. 1B, or the channel changing query 144 shown in FIG. 1C. The graphic display may also take numerous other appropriate forms. Upon creation of the graphic display depicting a momentary program guide, the graphics processor 314 will send the video signal to an output 316 (e.g., an HDMI port) that is connected to the display that is playing the current running media program.

In operation, the guide generating device 304 may be a receiver box that is connected to a television. The guide generating device 304 may be connected to a cable TV feed. During normal operation, the TV feed may simply pass through the guide generating device 304 unaltered and may be put out to the television. When a break is about to occur in the program that is currently being watched, one of the remote servers 302 may send a signal via the network 306 to the guide generating device 304 indicating that a momentary program guide should be displayed. The guide generating device 304 may also be programmed to display a momentary program guide at pre-set times, such as at the top or bottom of every hour.

The guide generating device 304 may receive information from the remote servers 302 about the current running program and other programs that are scheduled to broadcast in the near future through a network interface such as an Ethernet card connected to an Internet connection. The network interface may pass this information to a processor that may carry out the process of the program selector 312 described above. The processor may read computer commands stored on a hard drive or other memory device and then execute the commands to create program suggestions based on the information received from the remote servers 302. The guide generating device 304 may then create a graphic output depicting the program suggestions with a graphic processor, such as a video card. The graphics processor may then overlay the display of the program suggestions over the current running media program and output the display to the connected television via an output such as a cable TV line or a set of RCA cables.

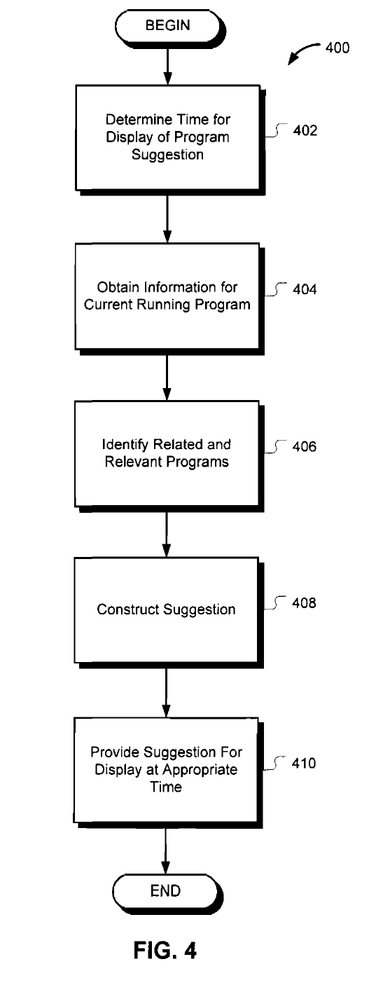

FIG. 4 is a flowchart of a method 400 for providing programming suggestions to a viewer of a television program. In general, a system using the method will be displaying a television program that is either currently being broadcast, or has previously been recorded. The system will determine an appropriate time to display one or more follow-up program suggestions. Next, the system obtains information about the current television program and then identifies related programs or otherwise relevant programs that are starting in the near future. The system then creates a suggestion for one or more programs and displays the suggestions to the user.

In the example depicted, while the user is watching a current running program, the method 400, at 402, determines a time to display one or more follow-up program suggestions. This may be just before the end of the current program, during a commercial break in the current program, or at a pre-set time such as the top or the bottom of the hour. In the case of sports games, the method 400 may determine that the difference in score is so high that the game has become boring, and therefore a program suggestion should be displayed. The system may also trigger the method 400 to begin when it has been determined that a highly relevant program is about to start. For example, a new episode of a user's favorite program, or a football game featuring a user's favorite team.

The method 400, at 404, obtains information about the current running program. This information may include the program title, genres, subject matter, actors, program writers, program creators or any other relevant information about the program. In alternative implementations, the method may also obtain similar information about the user's viewing preferences or additional information about the user, such as the user's location, age, gender, etc. This information may be used to determine which programs that are available to the user and airing within the near future, are related to the current running program or are otherwise relevant to the user.

The method 400, at 406, identifies potential follow-up programs that are related to the current running program, or may otherwise be of interest to the user. Information for potential follow-up programs that are airing on channels available to the user in the near future is collected and this information is compared to the information collected about the current running program at 404. The potential follow-up programs may also include previously recorded programs that are stored on a PVR or other video storage device connected to the media device or video files that are stored on a remote server, such as an Internet server. The potential follow-up programs are compared to the current running program based on some or all of the factors previously listed, or possibly other factors. Follow-up programs that are determined to be particularly related to the current running program will be selected to be displayed to the user.

The method 400, at 408, constructs a graphic display to present the program suggestions to the user. The graphic display is constructed based on the number or suggestions selected and the format of the suggestions. For example, if a single program has been selected to be suggested, a channel changing query offering the single suggestion will be displayed to the user. If several programs on multiple channels have been selected to be suggested, a momentary program guide in the form of a grid may be displayed to the user. There may exist numerous other formats in which the program suggestions may be displayed to the user.

The method 400, at 410, will display the program suggestions to the user at an appropriate time—for example, just as a commercial break starts, or as the credits for the current running program are running. In the situation in which the program suggestion has been triggered to appear because a user's favorite program is about to start, the program suggestion may be displayed shortly before the start of the user's favorite program.

Alternate methods similar to the method 400 may exist in which an additional step identifies a location on the television or media device to display the program suggestion. This method may determine if the momentary program guide should be overlaid on top of the currently running program, or if the currently running program should be shrunk down from it's original size and the momentary program guide displayed alongside the currently running program.

The momentary program guide may also take other appropriate forms. In addition, the method may determine if the momentary program guide should be located at the bottom of the display, the top of the display, the lower right-hand corner of the display, or another location on the display.

Another alternative method may generate programming suggestions by determining a time to display a program suggestion in the same manner as the method 400, and then merely showing a program guide listing channels that are located sequentially near the currently viewed channel, rather than showing channels containing a user's favorite programs or programs related to the current running program. This method may display the program guide in a manner similar to the method 400. However, in this particular implementation, the channels displayed may not be determined based on contextual relevance to the user or current running program.

Another alternate method similar to the method 400 may, upon display of the momentary program guide, wait for input from the user. In general, this input from the user may take the form of the user selecting one of the suggested programs shown on the momentary program guide. The method may then switch to the channel airing the program selected by the user either immediately, or when the selected program starts. If the user does not select one of the suggested programs, the momentary program guide may be removed from the display after a period of time and the media device may continue to show the current running program.

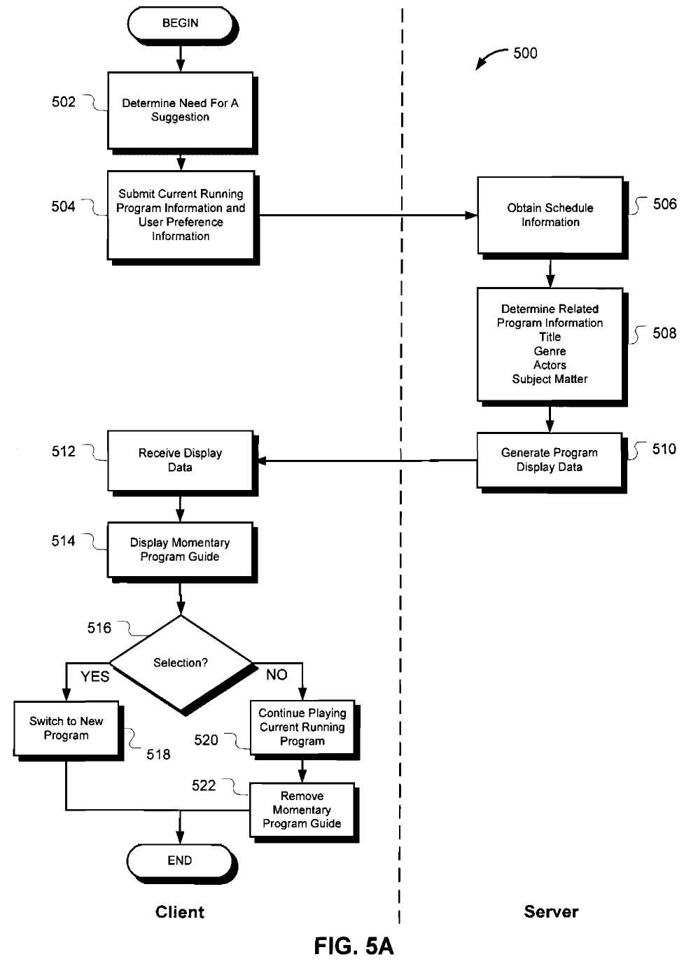

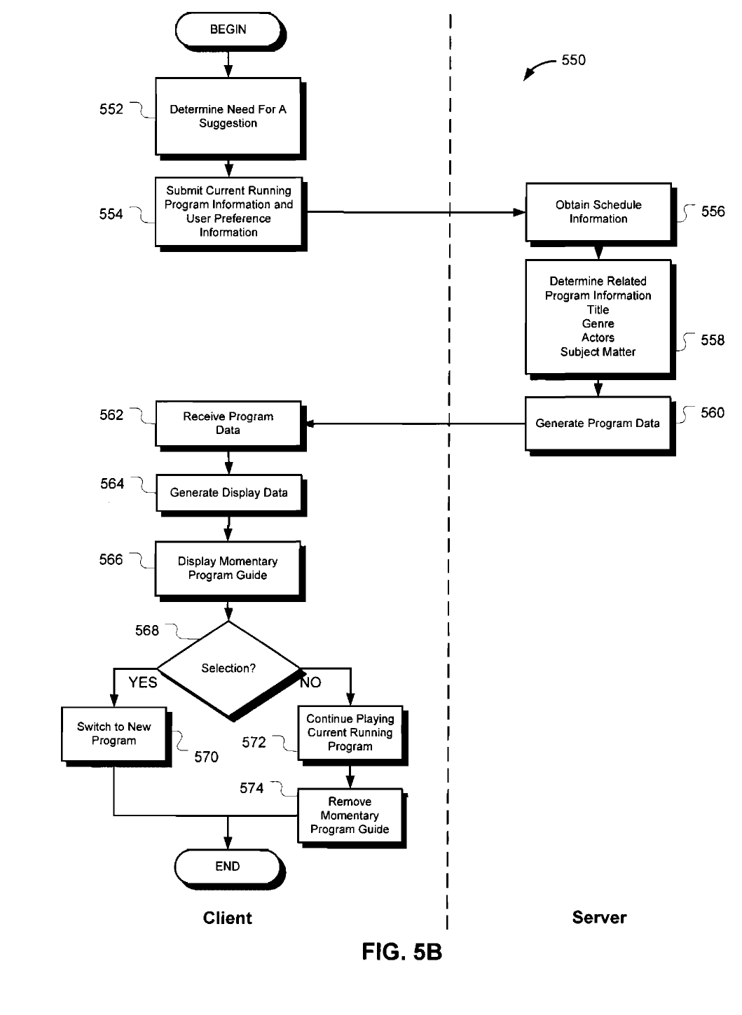

FIG. 5A is a swim lane diagram of a method 500 for providing programming suggestions to a viewer of a television program. In general, a client end system determines that a programming suggestion should be displayed to a user viewing a currently running television program. The client end system then submits information about the current running program and the user's viewing preferences to an remote server. The remote server then obtains schedule information for the user's head-end and selects programs to select to the user based on their relation to the current running program and the user's viewing preferences. Next, the remote server generates a display of a momentary program guide and sends the display data to the client end system. The client end system then displays the momentary program guide and waits for the user to make a selection. If the user selects one of the suggested programs, the client end system will switch to the selected program. If the user does not make a selection, the client end system will remove the momentary program guide from the display after a set period of time.

In the example depicted in FIG. 5A, at 502, a client system 501 determines that one or more program suggestions should be displayed to the user. This may be because the current running program is about to end or is reaching a break, such as a commercial break. At 504, the client system 501 sends information about the current running program and the user's viewing preferences to a remote server 505. The program information sent may include all relevant information about the current running program necessary to select related programs, or the program information sent may simply be the name of the current running program, or even just the channel that is currently being viewed. User viewing preference information may include user favorite programs, user favorite genres, user favorite subject matters, user favorite actors, user favorite writers, user favorite program creators, user favorite sports teams, or any other information that may be useful in selecting programs that may be relevant to the user.

At 506, the remote server 505 receives information submitted from the client system 501 and obtains schedule information. The remote server 505 determines which programs that are currently being broadcast, or are being broadcast in the near future, are available to the user, based on the user's head-end. At 508, the remote server 505 determines related program information for all of the programs available to the user. This information may include all information about the available programs that may be used to select suggested programs that are relevant to the current running program or the user's preferences. In the case where the information about the current running program submitted at 504 by the client system is only the name of the program, or the current channel, the remote server may also obtain information about the current running program during this step. The remote server may then compare information about the available programs and the current running program and user preferences to select one or more programs to suggest to the user.

At 510, the remote server generates a display of a momentary program guide containing program suggestions that is to be displayed over the current running program. This momentary program guide may be generated based on the suggested programs selected at 508 and may be formatted to best present the number and type of suggested programs. For example, if several programs being broadcast on multiple channels have been selected, a grid-like program guide may be appropriate, whereas if a single program has been selected, a single channel changing query may be appropriate. After generating the code for the momentary program guide, the remote server sends the display data to the client system.

At 512, the client system receives the display data generated by the remote server. At 514, the client system displays the momentary program guide containing program suggestions to the user. At 516, the client system waits for the user to select one of the suggested programs to view. If the user selects one of the suggested programs, the client system, at 518, will switch to the selected program, either immediately or at the end of the current running program. If the user chooses to ignore the momentary program guide and does not select one of the suggested programs, the client system, at 520, will continue playing the current running program. After a set period of time, the client system, at 522, will remove the momentary program guide from the visual display.

FIG. 5B is a another swim lane diagram of a method 550 for providing programming suggestions to a viewer of a television program. In general, the method 550 is similar to the method 500 shown in FIG. 5A. The main difference is that in the method 550, the server selects the suggested programs, but does not create the momentary program guide display. The display is generated by the client system.

In the example depicted in FIG. 5B, a client system, at 552, determines that one or more program suggestions should be displayed to the user. At 554, the client system submits information about the current running program and the user's viewing preferences to a remote server.

At 556, the remote server receives information submitted from the client system and obtains schedule information. The remote server determines which programs scheduled to broadcast in the near future are available to the user, based on the user's head-end. At 558, the remote server determines related program information for all of the programs available to the user. This information may include all information about the available programs that may be used to select suggested programs that are relevant to the current running program or the user's viewing preferences. At 560, the remote server compares information about the available programs and the current running program and user preferences to select one or more programs to suggest to the user. The remote server then transmits the list of suggested programs to the client system.

At 562, the client system receives the list of suggested programs generated by the server. At 564, the client system generates a display of a momentary program guide containing the selected program suggestions. The momentary program guide may be formatted to best present the number and type of suggested programs. The momentary program guide may contain relevant information about each of the suggested programs, which may including the program title, the channel broadcasting the program, the broadcast time, a brief description of the program, a list of the main actors, the writers, the producers, or any other information determined to be relevant that may help the user decide what program to watch next.

At 566, the client system displays the momentary program guide over or alongside the current running program. At 568, the client system waits for the user to select one of the suggested programs. If the user selects one of the suggested programs, the client system, at 570, will switch to the selected program, either immediately or at the end of the current running program. If the user chooses to ignore the momentary program guide and does not select one of the suggested programs, the client system, at 572, will continue playing the current running program. After a set period of time, the client system, at 574, will remove the momentary program guide from the visual display.

In addition to the two methods shown in FIG. 5A and FIG. 5B, other implementations may exist in which various functions which are described above as being carried out by the remote server may be carried out by the client system, or in which various functions described above as being carried out by the client system may be carried out by the remote server. For example, the remote server, instead of the client system, may determine that a momentary program guide should be displayed. The remote server may also store the information on the current running program and the user's viewing preferences. Alternate implementations may exist in which the client system obtains schedule information and determines which programs are available to the user. The client system may also determine related program information for the potential follow-up programs and select which programs should be suggested to the user.

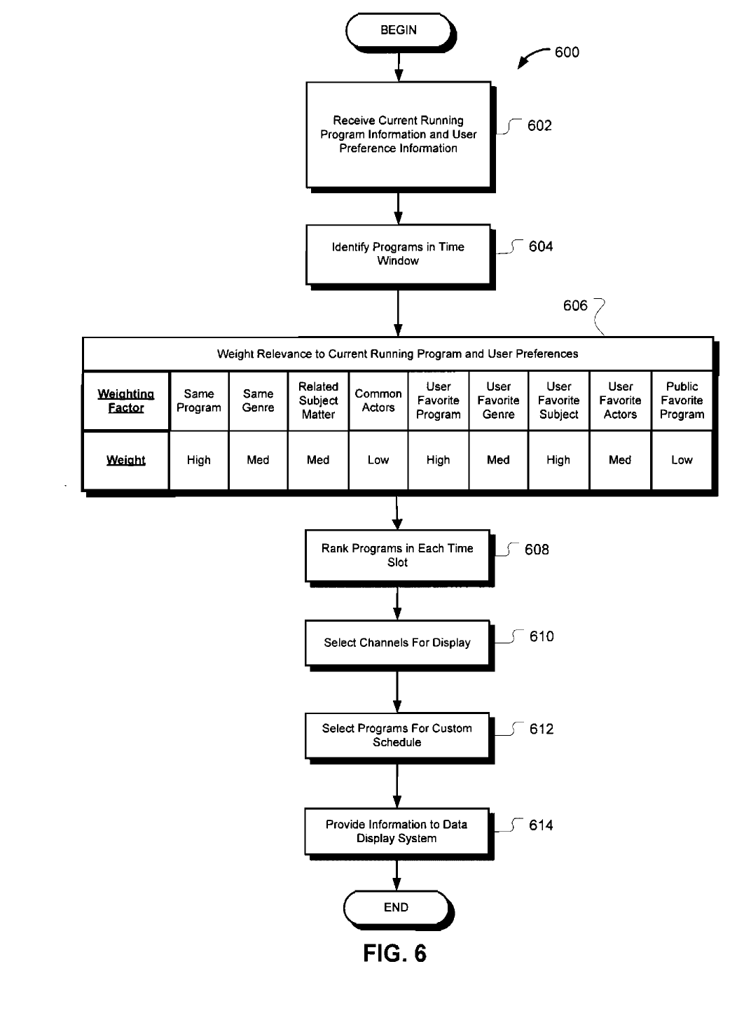

FIG. 6 is a flowchart of a method 600 for selecting and showing programs targeted to a user. In general, the method 600 shows a more detailed version of the process for selecting suggested follow-up programs described above. The method 600 receives information about the current running program and the user's viewing preferences. The method 600 then determines which possible follow-up programs are available to the user, and compares information about the possible follow-up programs to the current running program and user preference information. Based on these information comparisons, the method 600 ranks the potential follow-up programs based on how related they are to the current running program and to the user's viewing preferences. The method 600 then selects the programs that are determined to be most relevant to the user and selects the channels that are broadcasting the greatest number of relevant programs. The program suggestions are then displayed to the user.

In the example depicted in FIG. 6, the method 600, at 602, receives current running program information and user preference information. In addition to information on the user's viewing preferences, the method 600 may also receive information about the user's location, gender, age, number and age of children, hobbies, or any other information that may be relevant in selecting follow-up program suggestions. The method 600 may also receive information about programs that are stored on the user's PVR. For example, if the user's PVR contains several episodes of The Simpsons, an upcoming episode of The Simpsons may be a relevant suggestion.

The method 600, at 604, identifies all programs available to the user that are scheduled to broadcast in the determined time window. In general, this time window may be the next few hours, but the time window may be shorter or longer. The method 600, at 606, weights the relevance of each available program occurring within the time window to the current running program and the user's viewing preferences. Here, each potential follow-up program is compared to the current running program and the user's viewing preferences based on several weighting factors. Weighting factors for a program may include: same program as current running program; same genre as current running program; related subject matter to current running program; common actors to current running program; same writers as current running program; same producers as current running program; user favorite program; user favorite genre; user favorite subject matter; user favorite actors; user favorite writers, public favorite program; and award winning program. Weighting of the factors may also include any other appropriate means for comparing two programs or for selecting a follow-up program.

In addition, but not shown, the system may take into account a “People like me” factor. Such a factor may be based on a feature vector for the shows the user watches and the shows that other users watch. The system may also track user ratings of the programs. Using such a technique, a user may be determined to have similar interests to other people based on commonality of viewing history (and perhaps commonality of positive or negative reactions). Then, a show within a group of candidate shows in a proper time period (or stored on a server or the user's client device) may be selected according to shows that other people like the user have watched, enjoyed (as determined by a positive rating), or for which other users have subscribed to record one or more episodes of a series.

In addition to comparing the same weighting factors for potential follow-up programs to the current running program, the weighting factors may be cross referenced. The actors for the current running program may be compared against the subject matter of potential follow-up programs. In this example, if the movie “Ace Ventura” starring Jim Carrey is currently playing, an upcoming documentary on Jim Carrey may be a relevant program to suggest to the user. The user's viewing preferences may also be cross referenced against the properties of a potential follow-up program. For example, if Friends is a user favorite program, an episode of Inside The Actor's Studio featuring the cast of Friends may be a relevant program to suggest to the user.

In the case of sports programs, weighting factors may include: user favorite team or teams, user favorite athlete, same sport as current running program, user favorite sport, team or teams from same conference as user favorite team, point spread, playoff game, game with playoff implications, team from same area as user, or any other appropriate factors.

Each weighting factor is assigned a weight value. The weight value for each weighting factor is based on how relevant the particular weighting factor is to selecting program suggestions that may be of interest to the user. For example, a program that is the same program as the current running program may be weighted as highly relevant to the user, where as a public favorite program may be less relevant to the user. In the example shown in FIG. 6, the weight values are High, Medium, and Low. In other implementations, the weights may be given a numerical value or another appropriate value. For example, a program about a user's favorite subject matter can be given a High weight value. A program that is the same genre as the current running program can be given a Medium weight value. A program featuring common actors to the current running program is given a Low weight value.

Once the potential follow-up programs have been assigned weight values, the method 600, at 608, ranks the potential follow-up programs based on their assigned weight values. The programs with the highest weight value will be ranked highest. The method 600, at 610, selects programs to be included in the custom schedule that is displayed to the user. The highest ranked programs will be selected as program suggestions. If several programs have similarly high weight values, all of those programs will be selected to be suggested to the user. If one program has a significantly higher weight value than any other program, this single program may be be selected to be suggested to the user. In this example, the single program suggestion may most likely be displayed as a channel changing query.

The method 600, at 612, selects the channels to be displayed to the user. The channels selected will be the channels that are scheduled to broadcast the selected follow-up programs. An implementation may exist in which a channel that is broadcasting more than one relatively highly weighted program may be selected over a channel that is broadcasting only one highly weighted program, even if the relevant program on the second channel is weighted higher than any one of the relevant programs on the first channel.

After selecting which channels to display to the user, the method 600, at 614, provides information about the selected channels and the programs being broadcast on those channels to a data display system. The data display system may then use this information to generate a momentary program guide to display to the user.

In operation, a system located either at the client end unit or on a remote server may receive information about a user's viewing preferences and the television show the user is currently watching. For example, the user may be watching an episode of The Simpsons. The system may receive information indicating that the current program is The Simpsons; it is a cartoon directed towards adults; it features Dan Castellaneta, Julie Kavner, Yeardley Smith, Nancy Cartwright, and Hank Azaria; it was created by Matt Groening, and any other relevant information about the program. Other relevant information may include the subject matter of the current episode or guest stars appearing in the current episode. The system may also receive information about the user's viewing preferences. For example, the user's viewing history may indicate a preference for cartoons and comedy programs.

In this example, the system may then determine which programs are available to the user and scheduled to broadcast in the next two hours. The system may then compare information about these potential follow-up programs to determine which programs may be related to The Simpsons or to the user's viewing preferences. For example, an upcoming episode of Futurama may be selected as being related to The Simpsons since it is also a cartoon directed towards adults, has the same creator as The Simpsons, and features some of the same voice actors. An episode of South Park may also be selected since it is also a cartoon directed towards adults. Information indicating that viewers of The Simpsons generally enjoy South Park may be used to make this selection. If no other programs that are highly related to The Simpsons are being broadcast in the next two hours, an episode of The Daily Show may be suggested to the user based on the user's program viewing history.

Once these programs have been selected to be displayed to the user, the system will generate a momentary program guide and display the channels that are broadcasting these programs to the user.

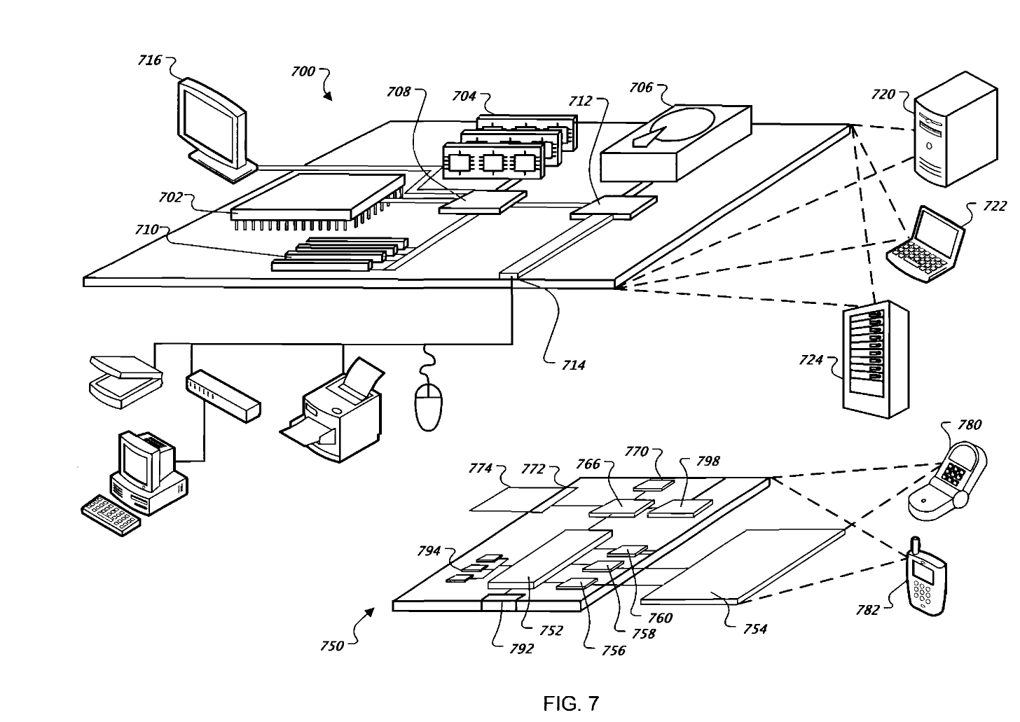

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made. For example, various forms of the flows shown above may be used, with steps re-ordered, added, or removed. Also, although several applications of the electronic program guide systems and methods have been described, it should be recognized that numerous other applications are contemplated. Moreover, although many of the embodiments have been described in relation to an electronic program guide, that term should be understood to include various forms of mechanisms for displaying media content to a user or users of various electronic devices such as televisions and mobile devices. Accordingly, other embodiments are within the scope of the following claims.

What is claimed is:

1. A computer-implemented method, comprising:
determining a time relative to a playing media program to insert a user notification;
automatically generating a suggestion regarding a media program other than the playing media program to be presented to an audience member of the playing media program;
providing, in a format for presentation on a user-related media player, the generated suggestion at the location in the playing media program, and
causing the generation of a control that, when selected performs an action related to the non-playing media program.

2. The computer-implemented method of claim 1, wherein determining the time relative to the playing media program comprises selecting a time for display of the user notification.

3. The computer-implemented method of claim 2, wherein the time is selected as a period relative to an endpoint of a program segment.

4. The computer-implemented method of claim 2, wherein the time is selected as a clock-based time.

5. The computer-implemented method of claim 4, wherein the clock-based time is the top or bottom of an hour.

6. The computer-implemented method of claim 1, wherein the generated suggestion includes a programming schedule grid.

7. The computer-implemented method of claim 6, wherein the programming schedule grid displays a personalized channel.

8. The computer-implemented method of claim 1, wherein the playing media program is recorded on a device operated by the user, and the non-playing media program is a broadcast program.

9. The computer-implemented method of claim 1, further comprising transmitting the generated suggestion from a server to a remote display device.

10. The computer-implemented method of claim 1, further comprising removing the display of the generated suggestion after a predetermined time period if the suggestion is not acted upon.

11. The computer-implemented method of claim 1, wherein the suggestion is generated based on a similarity in subject matter between the playing program and the non-playing program.

12. The computer-implemented method of claim 1, further comprising determining that the non-playing program is available for display to a user before providing the generated suggestion.

13. A computer-readable media having instructions recorded thereon, the instructions when executed, performing the actions of:
determining a time relative to a playing media program to insert a user notification;
automatically generating a suggestion regarding a media program other than the playing media program to be presented to an audience member of the playing media program;
providing, in a format for presentation on a user-related media player, the generated suggestion at the location in the playing media program, and
causing the generation of a control that, when selected, performs an 11 action related to the non-playing media program.

14. The media of claim 13, wherein the generated suggestion includes a programming schedule grid.

15. The media of claim 14, wherein the programming schedule grid displays a personalized channel.

16. The media of claim 13, wherein the suggestion is generated in a portable program module over a small portion of the playing media program.

17. A computer-implemented method, comprising:
automatically identifying an event, in a display of a first media program on a display device, for triggering a suggestion about a second media program related to the first media program;
causing the suggestion to be displayed on the display device with the first media program; and
providing information that causes the display device to switch to the second media program as a result of a user response to the suggestion.

18. The computer-implemented method of claim 17, wherein the suggestion includes a program associated with content of the playing program or with interests associated with a user associated with the display device.

19. The computer-implemented method of claim 18, wherein the suggestion includes a plurality of programs that are each associated with content in the playing program or with interests associated with the user.

20. A computer-implemented system for generating media programming information, comprising:
a network interface to receive media programming information over an internet connection;
a memory storing commands that, when executed, cause a suggestion about a non-playing media program to be provided over a playing media program; and
a processor operating a program selector to identify characteristics about the playing program or a user associated with the playing program and to select the non-playing media program based on the identified characteristics.

21. The system of claim 20, wherein the network interface, memory, and processor are on a client device associated with a media player.
